(19) United States
(12) Patent Application Publication
(10) Pub. No.: US 2022/0325068 A1
(43) Pub. Date: Oct. 13, 2022

(54) HIGH SOLVATING MIXED TEREPHTHALATE ESTER PLASTICIZER COMPOSITIONS

(71) Applicant: Eastman Chemical Company, Kingsport, TN (US)

(72) Inventors: Joseph Alexander DeLoach, Jonesborough, TN (US); Javier Martinez Grajeda, Kingsport, TN (US); Curtis Louis Schilling, III, Kingsport, TN (US); Phillip Wayne Turner, Blountville, TN (US)

(73) Assignee: Eastman Chemical Company, Kingsport, TN (US)

(21) Appl. No.: 17/594,969

(22) PCT Filed: Jun. 12, 2020
(86) PCT No.: PCT/US2020/037365

§ 371 Date: Nov. 4, 2021

Related U.S. Application Data
(60) Provisional application No. 62/866,747, filed on Jun. 26, 2019.

(51) Int. Cl. C08K 5/12

(52) U.S. Cl. CPC C08K 5/12

(57) ABSTRACT

The present application discloses plasticizer compositions comprising: (I) a compound of formula I: wherein R¹, R², and n are defined herein. The application also discloses resin compositions comprising the compound of formula I.

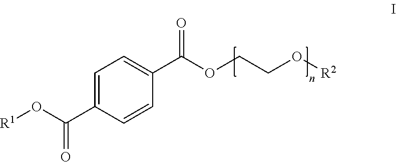

### BACKGROUND OF THE INVENTION

Plasticizers can be grouped into categories based on the effects they have on the polymer formulations which contain them. The plasticizers with the highest sales volumes are referred to as general purpose plasticizers. As their name implies, they typically are incorporated at the highest proportion of the total plasticizers used. Examples of general purpose plasticizers include di-2-ethylhexyl phthalate, diisononyl phthalate, diisononyl 1,2-cyclohexanedicarboxylate, and di-2-ethylhexyl terephthalate. The term “secondary plasticizers” can have several meanings. The term is most often applied to additives which do not have a strong plasticizing effect but provide another useful function. For example, hydrocarbons such as mineral oils can be used to reduce the viscosity of a polyvinyl chloride (PVC) plastisol, but they have little to no plasticizing effect as measured by the hardness or the fusion rate of the formulation. Such materials are often referred to as extenders or diluents. Highly solvating plasticizers show particularly high affinity for the polymers with which they are used. In PVC, highly solvating plasticizers are more efficient than general purpose plasticizers, most often measured by the reduction of the hardness of the final product per unit of plasticizer dosage. In PVC formulations, highly solvating plasticizers are often referred to as fast-fusing plasticizers, since they also reduce the time and temperature required for fusion compared to the general purpose plasticizers. Several types of esters can be classified as highly solvating plasticizers. These include phthalates based on lower alcohols such as dibutyl phthalate, and/or alcohols with aromatic components such as butyl benzyl phthalate. Dibenzoates are another class of highly solvating plasticizers, such as diethylene glycol dibenzoates. Terephthalates based on lower alcohols can also be high solvating plasticizers. Examples include dibutyl terephthalate and dipentyl terephthalate.

Although high solvating plasticizers can provide both product performance and processing advantages, they can have drawbacks. Highly solvating plasticizers are typically more expensive than general purpose plasticizers. They are generally lower molecular weight, and consequently more volatile, than general purpose plasticizers. Their high solvation can result in higher plastisol viscosities than obtained with general purpose plasticizers. Finally, many high solvating plasticizers can have relatively high freezing temperatures. For example, diethylene glycol dibenzoate has two crystal forms which melt at 16° C. and 28° C., respectively. These high freezing temperatures necessitate heated storage and transfer lines, an additional capital investment and ongoing operating expense. Development of high solvating plasticizers which do not have these drawbacks has been a very active field of investigation within the plasticizer industry.

### SUMMARY OF THE INVENTION

The present application discloses a plasticizer composition comprising: (I) a compound of formula I:

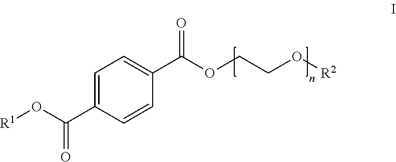

wherein: R¹ is (C₃₋₆)alkyl; R² is (C₁₋₆)alkyl; and n is an integer of 1, 2 or 3. The present application discloses PVC compositions comprising the compound of formula I. The present application also discloses a compound of formula IA:

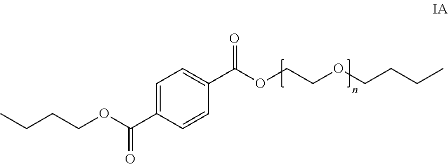

wherein n is 1 or 2, and plasticizer compositions comprising the compound of formula IA. The application also discloses PVC compositions comprising the plasticizer composition comprising the compound of formula IA.

### DETAILED DESCRIPTION

### Definitions

As used herein, the terms “a,” “an,” and “the” mean one or more.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, each numerical parameter should at least be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10. Also, a range associated with chemical substituent groups such as, for example, “C₁ to C₅ hydrocarbons” or “(C₁₋₅) hydrocarbons”, is intended to specifically include and disclose C₁ and C₅ hydrocarbons as well as C₂, C₃, and C₄ hydrocarbons. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

It is to be understood that the mention of one or more process steps does not preclude the presence of additional process steps before or after the combined recited steps or intervening process steps between those steps expressly identified. Moreover, the lettering of process steps or ingredients is a convenient means for identifying discrete activities or ingredients and the recited lettering can be arranged in any sequence, unless otherwise indicated.

As used herein the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

“Alkyl” groups suitable for use herein can be straight, branched, or cyclic, and can be saturated or unsaturated. Alkyl groups suitable for use herein include any (C₁₋₂₀), (C₁₋₁₂), (C₁₋₅), or (C₁₋₃) alkyl groups. In various embodiments, the alkyl can be a C₁₋₅ straight chain alkyl group. In still other embodiments, the alkyl can be a C₁₋₃ straight chain alkyl group. Specific examples of suitable alkyl groups include, but are not limited to, methyl, ethyl, n-propyl, isopropyl, n-butyl, isobutyl, sec-butyl, tert-butyl, pentyl, hexyl, octyl, decyl, dodecyl, cyclopentyl, and cyclohexyl groups. Examples such as propyl, butyl, decyl, and the like are not limited to the normal forms, they also include the branched forms. For example, propyl includes n-propyl and isopropyl.

“Stabilizer” means any additive added to a formulation that helps to prevent the formulation from degrading. Classes of stabilizers include antioxidants, light stabilizers, acid scavengers, heat stabilizers, flame retardants, and biocides.

Antioxidants are chemicals used to interrupt degradation processes during the processing of materials. Antioxidants are classified into several classes, including primary antioxidant, and secondary antioxidant.

“Primary antioxidants” are antioxidants that act by reacting with peroxide radicals via a hydrogen transfer to quench the radicals. Primary antioxidants generally contain reactive hydroxy or amino groups such as in hindered phenols and secondary aromatic amines. Examples of primary antioxidants include Cyanox™ 1790, 2246, and 425; Topanol® CA (4-[4,4-bis(5-tert-butyl-4-hydroxy-2-methylphenyl)butan-2-yl]-2-tert-butyl-5-methylphenol), Irganox™ 1010, 1076, 1726, 245, 1098, 259, and 1425; Ethanox™ 310, 376, 314, and 330; Evernox™ 10, 76, 1335, 1330, 3114, MD 1024, 1098, 1726, 120. 2246, and 565; Anox™ 20, 29, 330, 70, IC-14, and 1315; Lowinox™ 520, 1790, 22IB46, 22M46, 44B25, AH25, GP45, CA22, CPL, HD98, TBM-6, and WSP; Naugard™ 431, PS48, SP, and 445; Songnox™ 1010, 1024, 1035, 1076 CP, 1135 LQ, 1290 PW, 1330FF, 1330PW, 2590 PW, and 3114 FF; and ADK Stab AO-20, AO-30, AO-40, AO-50, AO-60, AO-80, and AO-330.

“Phenolic antioxidants” are primary antioxidants having at least one phenolic moiety. Non-limiting examples include Cyanox 1790, Cyanox 2246, Cyanox 425, Ethanox 330, Irganox 1330, Irganox 245, Irganox 259, Irganox 1010, Irganox 1035, Irganox 1076, Irganox 1098, Irganox 1425, Irganox 3114, and Topanol® CA.

“Secondary antioxidants” are often called hydroperoxide decomposers. They act by reacting with hydroperoxides to decompose them into nonreactive and thermally stable products that are not radicals. They are often used in conjunction with primary antioxidants. Examples of secondary antioxidants include the organophosphorous (e.g., phosphites, phosphonites) and organosulfur classes of compounds. The phosphorous and sulfur atoms of these compounds react with peroxides to convert the peroxides into alcohols. Examples of secondary antioxidants include Ultranox 626, Ethanox™ 368, 326, and 327; Doverphos™ LPG11, LPG12, DP S-680, 4, 10, S480, and S-9228; Evernox™ 168 and 626; Irgafos™ 126 and 168; Weston™ DPDP, DPP, EHDP, PDDP, TDP, TLP, and TPP; Mark™ CH 302, CH 55, TNPP, CH66, CH 300, CH 301, CH 302, CH 304, and CH 305; ADK Stab 2112, HP-10, PEP-8, PEP-36, 1178, 135A, 1500, 3010, C, and TPP; Weston 439, DHOP, DPDP, DPP, DPTDP, EHDP, PDDP, PNPG, PTP, PTP, TDP, TLP, TPP, 398, 399, 430, 705, 705T, TLTTP, and TNPP; Alkanox 240, 626, 626A, 627AV, 618F, and 619F; and Songnox™ 1680 FF, 1680 PW, and 6280 FF.

“Acid scavengers” are additives that neutralize acids formed during the processing of polymers. Examples of acid scavengers include Hycite 713; Kisuma DHT-4A, DHT-4V, DHT-4A-2, DHT-4C, ZHT-4V, and KW2200; Brueggemann Chemical Zinc Carbonate RAC; Sipax™ AC-207; calcium stearate; Baerlocher GL 34, RSN, GP, and LA Veg; Licomont CAV 102; FACI Calcium Stearate DW, PLC, SP, and WLC; Hangzhou Hitech Fine Chemical: CAST, and ZnST; Songstab™ SC-110, SC-120, SC-130, SM-310, and SZ-210; Sun Ace SAK-CS, SAK-DSC, SAK-DMS, SAK-DZS, and SAK-KS; US Zinc Oxide 201, 205 HAS, 205H, 210, and 210E; Drapex™ 4.4, 6.8, 39, 391, 392, and 392S; Vikoflex™ 4050, 5075, 7170, 7190, 7040, 9010, 9040, and 9080; Joncryl™ ADR 4468, and ADR 4400; Adeka CIZER D-32; Epon™ 1001 F, 1002F, and 1007F; Aralidite™ ECN 1299, 1273, 1280, 1299, and 9511; Dynamar RC 5251Q; and Nexamite PBO.

A “salt stabilizer” can be incorporated into the composition to stabilize the composition during processing. The cation component of the salt stabilizer is chosen from aluminum, calcium, magnesium, copper, cerium, antimony, nickel, cobalt, manganese, barium, strontium, zinc, zirconium, tin, cadmium, chromium and iron cations; and the anion component of the salt stabilizer is an (C₆₋₂₀)alicyclic carboxylic acid, a (C₂₋₂₀)alkyl carboxylic acid, or a (C₆₋₂₀)alkenyl carboxylic acid. Examples of the (C₆₋₂₀)alicyclic carboxylic acid, the (C₆₋₂₀)alkyl carboxylic acid, or the (C₆₋₂₀)alkenyl carboxylic acid include naphthenic acid, abietic acid, cyclohexane carboxylic acid, cyclohexane propionic acid, 3-methyl-cyclopentyl acetic acid, 4-methylcyclohexane carboxylic acid, 2,2,6-trimethylcyclohexane carboxylic acid, 2,3-dimethylcyclopentyl acetic acid, 2-methylcyclopentyl propionic acid, palmitic acid, stearic acid, oleic acid, lauric acid, and the like. Examples of the salt stabilizers include strontium naphthenate, copper naphthenate, calcium naphthenate, zinc naphthenate, magnesium naphthenate, copper abietate, magnesium abietate, titanium acetate, titanium propionate, titanium butyrate, antimony acetate, antimony propionate, antimony butyrate, zinc acetate, zinc propionate, zinc butyrate, tin acetate, tin propionate, tin butyrate, 2-ethylhexylamine, bis(2-ethylhexyl)amine, tetrabutyl phosphonium bromide, dodecyldimenylamine, N,N-dimethylbenzylamine, tetramethyl guanidine, benzyltrimethyl ammonium hydroxide, tetrabutyl ammonium hydroxide, 2-ethylimidazole, DBU/2-ethylhexanoic acid, aluminum acetylacetonate, aluminate lactate, bismuth octoate, calcium octoate, cerium naphthenate, chromium(III) 2-ethylhexanoate, cobalt octoate, copper II acetylacetonate, Iron (III) acetylacetonate, manganese naphthenate, nickel acetylacetonate, stannous octoate, zinc acetate, zinc acetylacetonate, zinc octoate, zirconium octoate, and the like.

“Flame retardant” are materials that increase ignition time, reduce flame spreading and rate of burning. The flame retardant should have a high decomposition temperature, low volatility, a minimum effect on thermal and mechanical properties and good resistance to light and ultra-violet radiation. Examples of flame retardants that may be used include halogen containing compounds and phosphorous containing organic compounds such as triaryl, trialkyl or alkyl diaryl phosphate esters. Other materials that may be used include chloroparaffins, aluminum trihydrate, antimony oxides, or zinc borate.

“Fillers” are materials added to formulations or compositions primarily to reduce cost, increase the output of dry blending, increase electrical resistance, increase resistance to ultra-violet light, increase hardness, provide improved heat transmission, and to increase the resistance of heat deformation. Fillers can also impact anti-blocking or anti-slip performance of the compositions. Nonlimiting examples of fillers included calcium carbonate, clays, silica, dolomite, bauxite, titanium dioxide. The particular particle size distribution and average surface area of the filler will be chosen according to the properties it is desired to impart, as would be apparent to one of skill in the art.

“Processing aids” are chemicals that reduce the adhesion of the compositions with machinery surfaces during processing. The lubricants also affect the frictional properties between the polymer resin particles during processing. Nonlimiting examples of lubricants include stearic acid, metal stearates, waxes, silicon oil, mineral oil, and synthetic oils.

### Composition of Matter

The present application discloses a compound of formula IA:

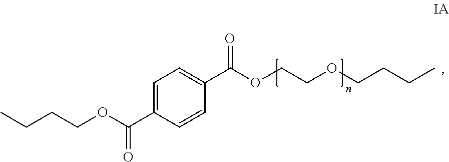

wherein n is 1 or 2.

In one embodiment, n is 1. In one embodiment, n is 2.

In one embodiment, the compound of formula IA is

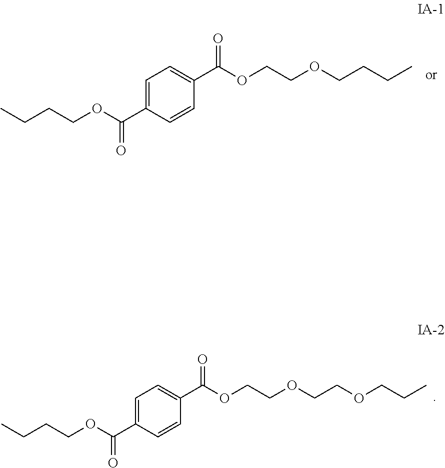

In one class of this embodiment, the compound of formula IA is

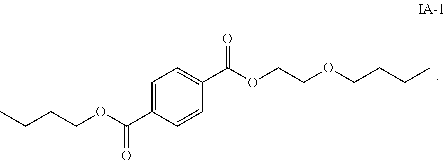 [SMILES: CCCCOCCOC(=O)c1ccc(C(=O)OCCCC)cc1]

In one class of this embodiment, the compound of formula IA is

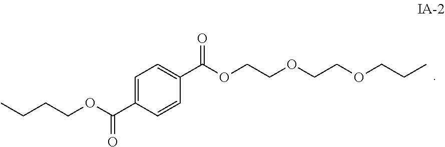 [SMILES: CCCCOC(=O)c1ccc(C(=O)OCCOCCOCCC)cc1]

### Plasticizer Composition

The present application discloses a plasticizer composition comprising: (I) a compound of formula I:

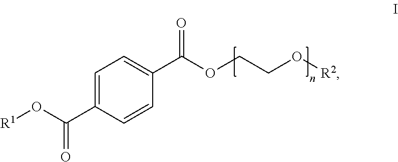

wherein: R¹ is (C₃₋₆)alkyl; R² is (C₁₋₆)alkyl; and n is an integer of 1, 2 or 3.

In one embodiment, the freezing point of the plasticizer composition is less than −10° C. In one embodiment, the freezing point of the plasticizer composition is less than or equal to −15° C. In one embodiment, the freezing point of the plasticizer composition is less than −20° C.

In one embodiment, R¹ is unbranched or branched propyl, unbranched or branched butyl, unbranched or branched pentyl, or unbranched or branched hexyl.

In one embodiment, R¹ is unbranched or branched butyl.

In one embodiment, R² is methyl, ethyl, unbranched or branched propyl, unbranched or branched butyl, unbranched or branched pentyl, or unbranched or branched hexyl.

In one embodiment, R² is unbranched or branched butyl.

In one embodiment, n is 3. In one embodiment, n is 1 or 2. In one class of this embodiment, n is 1. In one class of this embodiment, n is 2.

In one embodiment, the compound of formula I is present at from 20 to 60 weight % based on the total weight of the plasticizer composition. In one embodiment, the compound of formula I is present at from 30 to 50 weight % based on the total weight of the plasticizer composition. In one embodiment, the compound of formula I is present at from 20 to 45 weight % based on the total weight of the plasticizer composition. In one embodiment, the compound of formula I is present at from 45 to 60 weight % based on the total weight of the plasticizer composition. In one embodiment, the compound of formula I is present at from 35 to 50 weight % based on the total weight of the plasticizer composition.

In one embodiment, the plasticizer composition further comprises: (II) a compound of formula II:

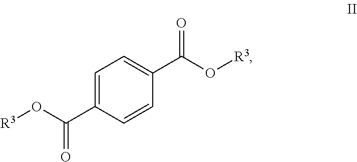

wherein each R³ is (C₃₋₆)alkyl.

In one class of this embodiment, R³ is unbranched or branched propyl, unbranched or branched butyl, unbranched or branched pentyl, or unbranched or branched hexyl. In one class of this embodiment, R³ is unbranched or branched butyl.

In one class of this embodiment, wherein the compound of formula II is present from 20 to 70 weight % based on the total weight of the plasticizer composition. In one class of this embodiment, wherein the compound of formula II is present from 29 to 65 weight % based on the total weight of the plasticizer composition. In one class of this embodiment, wherein the compound of formula II is present from 35 to 50 weight % based on the total weight of the plasticizer composition. In one class of this embodiment, wherein the compound of formula II is present from 50 to 70 weight % based on the total weight of the plasticizer composition.

In one class of this embodiment, the plasticizer composition further comprises: (III) a compound of formula III:

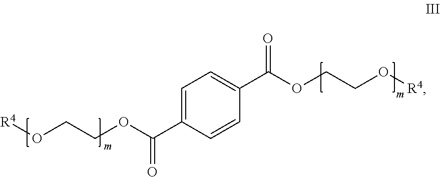

wherein: each R⁴ is (C₁₋₆)alkyl; and each m is 1, 2, or 3.

In one subclass of this class, each R⁴ is unbranched or branched propyl, unbranched or branched butyl, unbranched or branched pentyl, or unbranched or branched hexyl.

In one subclass of this class, each R⁴ is unbranched or branched butyl.

In one subclass of this class, each m is 3. In one subclass of this class, each m is 1 or 2. In one sub-subclass of this subclass, each m is 1. In one sub-subclass of this subclass, each m is 2.

In one subclass of this class, the compound of formula III is present from 2 to 30 weight % based on the total weight of the plasticizer composition. In one subclass of this class, the compound of formula III is present from 4 to 20 weight % based on the total weight of the plasticizer composition. In one subclass of this class, the compound of formula III is present from 2 to 15 weight % based on the total weight of the plasticizer composition. In one subclass of this class, the compound of formula III is present from 15 to 30 weight % based on the total weight of the plasticizer composition. In one subclass of this class, the compound of formula III is present from 10 to 20 weight % based on the total weight of the plasticizer composition.

In one subclass of this class, the freezing point of the plasticizer composition is less than −10° C. In one subclass of this class, the freezing point of the plasticizer composition is less than or equal to −15° C. In one subclass of this class, the freezing point of the plasticizer composition is less than −20° C.

In one embodiment, the plasticizer composition further comprises: (III) a compound of formula III:

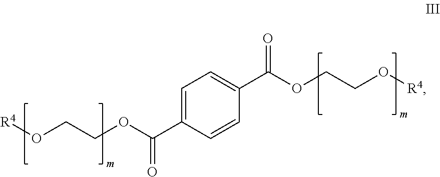

wherein: each R⁴ is (C₁₋₆)alkyl; and each m is 1, 2, or 3.

In one class of this embodiment, each R⁴ is unbranched or branched propyl, unbranched or branched butyl, unbranched or branched pentyl, or unbranched or branched hexyl.

In one class of this embodiment, each R⁴ is unbranched or branched butyl.

In one class of this embodiment, each m is 3. In one class of this embodiment, each m is 1 or 2. In one subclass of this class, each m is 1. In one subclass of this class, each m is 2.

In one class of this embodiment, the compound of formula III is present from 2 to 30 weight % based on the total weight of the plasticizer composition. In one class of this embodiment, the compound of formula III is present from 4 to 20 weight % based on the total weight of the plasticizer composition. In one class of this embodiment, the compound of formula III is present from 2 to 15 weight % based on the total weight of the plasticizer composition. In one class of this embodiment, the compound of formula III is present from 15 to 30 weight % based on the total weight of the plasticizer composition. In one class of this embodiment, the compound of formula III is present from 10 to 20 weight % based on the total weight of the plasticizer composition.

### Resin Compositions

The present application discloses a resin composition comprising: (I) a resin; and (II) a compound of formula I

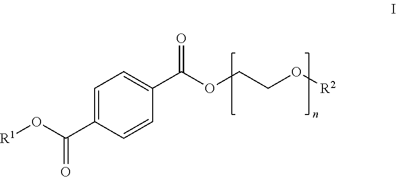

wherein: R¹ is (C₃₋₆)alkyl; R² is (C₁₋₆)alkyl; and n is an integer of 1, 2 or 3.

In one embodiment, R¹ is unbranched or branched propyl, unbranched or branched butyl, unbranched or branched pentyl, or unbranched or branched hexyl.

In one embodiment, R¹ is unbranched or branched butyl.

In one embodiment, R² is methyl, ethyl, unbranched or branched propyl, unbranched or branched butyl, unbranched or branched pentyl, or unbranched or branched hexyl.

In one embodiment, R² is unbranched or branched butyl.

In one embodiment, n is 3. In one embodiment, n is 1 or 2. In one class of this embodiment, n is 1. In one class of this embodiment, n is 2.

In one embodiment, the compound of formula I is present at from 20 to 60 weight % based on the total weight of the plasticizer composition. In one embodiment, the compound of formula I is present at from 30 to 50 weight % based on the total weight of the plasticizer composition. In one embodiment, the compound of formula I is present at from 20 to 45 weight % based on the total weight of the plasticizer composition. In one embodiment, the compound of formula I is present at from 45 to 60 weight % based on the total weight of the plasticizer composition. In one embodiment, the compound of formula I is present at from 35 to 50 weight % based on the total weight of the plasticizer composition.

In one class of this embodiment, R³ is unbranched or branched propyl, unbranched or branched butyl, unbranched or branched pentyl, or unbranched or branched hexyl. In one class of this embodiment, R³ is unbranched or branched butyl.

In one embodiment, the resin composition further comprising: (II) a compound of formula II:

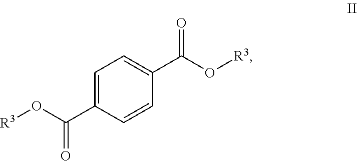

wherein each R³ is (C₃₋₆)alkyl.

In one class of this embodiment, R³ is unbranched or branched propyl, unbranched or branched butyl, unbranched or branched pentyl, or unbranched or branched hexyl. In one class of this embodiment, R³ is unbranched or branched butyl.

In one class of this embodiment, wherein the compound of formula II is present from 20 to 70 weight % based on the total weight of the plasticizer composition. In one class of this embodiment, wherein the compound of formula II is present from 29 to 65 weight % based on the total weight of the plasticizer composition. In one class of this embodiment, wherein the compound of formula II is present from 35 to 50 weight % based on the total weight of the plasticizer composition. In one class of this embodiment, wherein the compound of formula II is present from 50 to 70 weight % based on the total weight of the plasticizer composition.

In one class of this embodiment, the resin composition further comprising: (III) a compound of formula III:

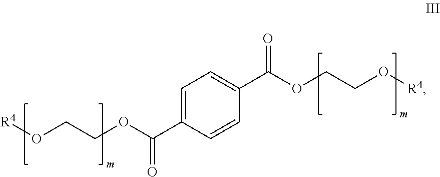

wherein: each R⁴ is (C₁₋₆)alkyl; and each m is 1, 2, or 3.

In one subclass of this class, R¹ is unbranched butyl; R² is unbranched butyl; each R³ is unbranched butyl; each R⁴ is unbranched butyl; each m is 1; and n is 1.

In one embodiment, the plasticizer composition further comprises: (III) a compound of formula III:

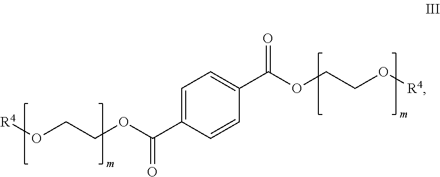

wherein: each R⁴ is (C₁₋₆)alkyl; and each m is 1, 2, or 3.

In one class of this embodiment, each R⁴ is unbranched or branched propyl, unbranched or branched butyl, unbranched or branched pentyl, or unbranched or branched hexyl.

In one class of this embodiment, each R⁴ is unbranched or branched butyl.

In one class of this embodiment, each m is 3. In one class of this embodiment, each m is 1 or 2. In one subclass of this class, each m is 1. In one subclass of this class, each m is 2.

In one class of this embodiment, the compound of formula III is present from 2 to 30 weight % based on the total weight of the plasticizer composition. In one subclass of this class, the compound of formula III is present from 4 to 20 weight % based on the total weight of the plasticizer composition. In one subclass of this class, the compound of formula III is present from 2 to 15 weight % based on the total weight of the plasticizer composition. In one subclass of this class, the compound of formula III is present from 15 to 30 weight % based on the total weight of the plasticizer composition. In one subclass of this class, the compound of formula III is present from 10 to 20 weight % based on the total weight of the plasticizer composition.

In one embodiment, the resin comprises a polyvinyl chloride, a polyvinyl acetate, an acrylic polymer, a vinyl chloride-containing copolymer or combinations thereof. In one class of this embodiment, the resin comprises a polyvinyl chloride. In one class of this embodiment, the resin comprises a polyvinyl acetate. In one class of this embodiment, the resin comprises an acrylic polymer. In one class of this embodiment, the resin comprises a vinyl chloride-containing copolymer.

In one embodiment, the resin composition further comprises other components, wherein the other components comprises a filler, a pigment, a stabilizer, a foaming agent, a hollow material, an elastomeric material, a rheology control additive, an adhesion promoter, or combinations thereof.

In one class of this embodiment, the other component is present from 10 to 300 parts per 100 parts resin.

In one class of this embodiment the filler comprises calcium carbonate, fly ash, or combinations thereof, and wherein the stabilizer comprises a metal soap, an epoxidized oil, an epoxidized fatty acid ester, an organotin compound, or combinations thereof.

### EXPERIMENTAL SECTION

### Abbreviations

° C. is degree Celsius; CE is comparative example; Ex is example; ° F. is degree Fahrenheit; GC is gas chromatography; min is minute(s); mm is millimeter; mol is moles; ppm is parts per million; MeOH is methanol; MS is mass spectrometry; PVC is polyvinyl chloride; rpm is revolutions per minute; sec is second(s); Temp is temperature; wt % is weight percent;

### Example 1: Synthesis of Butyl 2-Butoxyethyl Terephthalate Using Equimolar Alcohols

In a 2 liter three-neck round-bottom flask was loaded dimethyl terephthalate (2 mol), n-butanol (3 mol), 2-butoxyethanol (3 mol), and 1000 ppm titanium(IV) isopropoxide. The flask was equipped with a stir bar, an 8″ column loaded with Penn State packing, and a vapor-dividing head. The mixture was heated to reflux under a flow of nitrogen gas, and methanol was distilled off with the vapor-dividing head set to 30% take-off at 69° C. or below. When the theoretical amount of MeOH (4 mol) had been collected, the catalyst was quenched with 2.5 wt % aqueous sodium hydroxide, and the mixture further washed with saturated sodium chloride until the pH of the aqueous washes dropped to ˜9-10. The excess alcohol was stripped under reduced pressure at 150° C. After drying, the product was cooled to 90° C. and filtered through a glass fiber filter padded with diatomaceous earth. The composition of the final product as analyzed by GC area % was 30.6% dibutyl terephthalate (GC/MS retention time 12.99 min, molecular ion peak 278), 49.4% mixed butyl/2-butoxyethyl terephthalate (GC/MS retention time 14.61 min, molecular ion peak 322), and 19.6% di-2-butoxyethyl terephthalate (GC/MS retention time 16.02 min, molecular ion peak 366).

### Examples 2-6—Synthesis of Other Butyl/Glycol Ether Terephthalates

By adapting the procedure for the preparation of Ex 1, Ex 2-6 were prepared, by using different ratios of n-butanol and 2-butoxyethanol or 2-(2-butoxyethoxy)ethanol). The results of these preparations are shown in Table 1.

TABLE 1
Butyl/2-Butoxyethyl Terephthalate and Butyl/2-(2-Butoxyethoxy)ethyl)
Terephthalate Compositions

| | | Product Composition, GC Area % | | |
|---|---|---|---|---|
| | n-Butanol:2- | | n-Butyl 2- | |
| | Butoxyethanol | Di-n-Butyl | butoxyethyl | Di-2-Butoxyethyl |
| Ex # | molar feed ratio | terephthalate | terephthalate | terephthalate |
| 1 | 1:1 | 30.6 | 49.4 | 19.6 |
| 2 | 2:1 | 52.4 | 39.7 | 7.0 |
| 3 | 3:1 | 61.8 | 33.1 | 4.0 |
| | n-Butanol:2-(2- | | n-butyl 2-(2- | Di-2-(2- |
| | Butoxyethoxy)ethanol | Di-n-Butyl | Butoxyethoxy)ethyl | Butoxyethoxy)ethyl |
| Ex # | molar feed ratio | terephthalate | terephthalate | terephthalate |
| 4 | 1:1 | 29.1 | 49.8 | 19.6 |
| 5 | 2:1 | 54.4 | 38.0 | 6.0 |
| 6 | 3:1 | 64.0 | 30.0 | 3.9 |

Comparative Example 1 (CE 1) is dibutyl terephthalate, commercially available as Eastman Effusion Plasticizer by Eastman Chemical Company. Comparative Example 2 (CE 2) is dipropylene glycol dibenzoate, commercially available as Benzoflex 9-88 Plasticizer by Eastman Chemical Company. Comparative Example 3 (CE 3) is di(methoxyethyl) terephthalate. Comparative Example 4 (CE 4) is di(ethoxyethyl) terephthalate and Comparative Example 5 (CE 5) is di(ethoxyethyl) terephthalate. CE 1, CE 2 and CE 3 were obtained from commercial sources and used without further purification. CE 4 and CE 5 were prepared from dimethyl terephthalate and 2-methoxyethanol and 2-ethoxyethanol, respectively, in an analogous manner as Ex 1-6.

The freezing behavior was assessed by placing samples first in a refrigerator set to a temperature of 4° C. and held for seven days. Samples which remained liquid under those conditions were then transferred to a freezer set to a temperature of −15° C. and held for seven days. The freezing behavior is described in Table 2.

TABLE 2
Freezing Behavior of Glycol Ether-Based Terephthalates
and Controls

| Ex # | Observed Freezing Temperature, ° C. |
|---|---|
| 1 | <−15 |
| 2 | <−15 |
| 3 | >−15 |
| 4 | <−15 |
| 5 | A few crystals at −15° C. |
| 6 | >−15 |
| CE 1 | 16 |
| CE 2 | <−30 (literature value) |
| CE 3 | −48 (literature value) |
| CE 4 | >4 |
| CE 5 | >4 |

This experiment shows that some glycol ether-based terephthalates are prone to freezing at elevated temperatures. When 2-methoxyethanol and 2-ethoxyethanol are used as the sole alcohols to produce the terephthalate plasticizers, bulk freezing occurs above 0° C., as is also observed with di-n-butyl terephthalate. The mixed esters remain liquids below −15° C., unless a 3:1 molar ratio of n-butanol to 2-butoxyethanol or 2-(2-butoxyethoxy)ethanol is used to prepare the terephthalate, Ex 3 and 6. Even at that ratio, freezing occurs well below the temperatures it occurs when either n-butanol, or glycol ethers which provide comparable molecular weight as the mixed butyl/butoxyethyl terephthalate, are used as the sole alcohols.

### General Procedure for the Preparation and Evaluation of PVC Plastisols

In addition to the plasticizers described as Ex 1-6 and CE 1 to CE 4, the ingredients described in Table 3 were used in the formulations and test results described below. The term “phr” refers to the addition level in weight of the ingredient per 100 parts weight of the PVC resin. Each ingredient was obtained from the commercial sources and was used without further purification.

TABLE 3
Ingredients and additives used in PVC formulations.

| Material | Description | Supplier |
|---|---|---|
| Geon 121A | PVC paste resin, K- | Mexichem S.A.B. de |
| | 74 | C.V. |
| Eastman 168 ™ Non- | Bis(2-ethylhexyl) | Eastman Chemical |
| Phthalate Plasticizer | terephthalate | Company |
| Drapex ® 6.8 | Epoxidized soybean | Galata Chemicals |
| | oil | |
| Akcrostab ® LT-4798 | Barium/zinc stabilizer | Akcros Chemicals Inc. |

A FlackTek SpeedMixer™ model 600 FVZ was used to prepare PVC plastisols. The liquid additives were charged into a mixing cup and premixed until homogeneous. Then, the PVC resin was added, stirred to distribute with the liquid additives, and the cup was placed into the mixer. The contents were shaken in the mixer for 30 sec at 1200 rpm and the side of the container was scraped, then the contents were shaken in the mixer for 40 sec at 1600 rpm and the side of the container was scraped again. This process was repeated if necessary to ensure complete dispersion. The resulting plastisol was then deaerated in a desiccator to which vacuum was applied for 20 min.

### Fusion Determination

Fusion data were generated using a Brabender Intelli-Torque Plasti-Corder rheometer, in accordance with ASTM Method D2538, “Standard Practice for Fusion of PVC Compounds Using a Torque Rheometer.” Fusion times and temperatures are reported as the time and temperature, respectively, at which the peak mixer torque is recorded.

### Shore A Hardness

Shore A hardness values were determined in accordance with ASTM Method D2240, “Standard Test Method for Rubber Property—Durometer Hardness.” Specimens were prepared by fusing at 375° F. for 30 min. Five determinations were done per specimen, with readings taken 6 mm apart on the specimen, and the readings were averaged.

### Preparation of PVC Plastisols Ex 7-16

The general procedure for the preparation of PVC plastisols was followed using 100 phr Geon 121A PVC, 3 phr Drapex 6.8 epoxidized soybean oil, 3 phr Akcrostab® LT-4798 barium/zinc stabilizer, 42 phr Eastman 168™ plasticizer (DEHT), and 18 phr butyl 2-butoxyethyl terephthalate, Ex 1, yielding the plastisol as Ex 7. In a similar manner, PVC plastisols were produced from the plasticizers in Ex 2-6 and CE 1-CE 3, in each case substituting the plasticizer in these examples for the 18 phr butyl 2-butoxyethyl terephthalate in Ex 1, to produce plastisol Ex 8-12 and CE 13-CE 15.

Fusion time and Shore A hardness data were determined by the procedures noted above. The results are given in Table 4 and 5, respectively.

TABLE 4
Fusion Behavior of Ex 7-12 and CE 13-CE 15.

| Plasticizer | Plastisol | |
|---|---|---|
| Ex # | Ex # | Fusion Time, min |
| 1 | 7 | 15.7 |
| 2 | 8 | 15.2 |
| 3 | 9 | 14.6 |
| 4 | 10 | 17.4 |
| 5 | 11 | 15.5 |
| 6 | 12 | 16.4 |
| CE 1 | CE 13 | 14.9 |
| CE 2 | CE 14 | 16.2 |
| CE 3 | CE 15 | 19.2 |

The novel plasticizers Ex 1-3 and 5-6 compare favorably in the fusion behavior they confer in PVC plastisols to industry standard fast-fusing plasticizers dibutyl terephthalate (CE 1) and dipropylene glycol dibenzoate (CE 2). Surprisingly, the compositional differences between Ex 1-3, and Ex 5-6, do not significantly change the fusion behavior. This is unexpected when comparing the four carbon butyl radical to the 6 carbon and 1 oxygen 2-butoxyethyl radical, and the 8 carbon and 2 oxygen 2-(2-butoxyethoxy)ethyl radical. Plasticizer Ex 4 illustrates that when the 8 carbon and 2 oxygen 2-(2-butoxyethoxy)ethyl radical is used, more than an equimolar proportion of butanol is required to confer fusion at shorter times and lower temperatures.

TABLE 5
Shore A Hardness of Inventive Plasticizers
and Comparative Examples.

| Plasticizer | Plastisol | Shore A |
|---|---|---|
| Ex # | Ex # | Hardness |
| 1 | 7 | 70 |
| 2 | 8 | 69 |
| 3 | 9 | 67 |
| 4 | 10 | 70 |
| 5 | 11 | 69 |
| 6 | 12 | 68 |
| CE 1 | CE 13 | 69 |
| CE 2 | CE 14 | 71 |
| CE 3 | CE 15 | 72 |

Table 5 shows that the novel plasticizers Ex 1-6 compare favorably in plasticizer efficiency as measured by Shore A Hardness in PVC plastisols to industry standard high solvating plasticizers dibutyl terephthalate (CE 1) and dipropylene glycol dibenzoate (CE 2). Once again, the compositional differences between Ex 1-3, and Ex 4-6, do not significantly change the plasticizer efficiency. This is unexpected when comparing the four carbon butyl radical to the 6 carbon and 1 oxygen 2-butoxyethyl radical, and the 8 carbon and 2 oxygen 2-(2-butoxyethoxy)ethyl radical.

The inventive plasticizers are envisioned as being useful in a variety of applications. Non-limiting examples in polyvinyl chloride compositions include flooring, carpet backing, floor mats, wall coverings, dip and spray coated parts, and articles produced by rotational and injection molding. The inventive plasticizers are also envisioned as being useful in articles produced from polyvinyl chloride dry blends, such as articles produced by calendering and extrusion.

Other embodiments will be apparent to those skilled in the art from consideration of the specification and practice of the embodiments disclosed herein. It will be understood that variations and modifications can be effected within the spirit and scope of the disclosed embodiments. It is further intended that the specification and examples be considered as exemplary only, with a true scope and spirit of the disclosed embodiments being indicated by the following claims.

What is claimed is:

1. A plasticizer composition comprising: (I) a compound of formula I:
wherein: 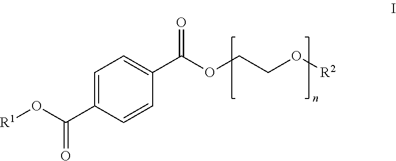
R¹ is (C₃₋₆)alkyl;
R² is (C₁₋₆)alkyl; and
n is an integer of 1, 2 or 3.

2. The plasticizer composition of claim 1, wherein R¹ is unbranched or branched butyl.

3. The plasticizer composition of claim 1, wherein R² is unbranched or branched butyl.

4. The plasticizer composition of claim 1, wherein the compound of formula I is present at from 20 to 60 weight % based on the total weight of the plasticizer composition.

5. The plasticizer composition of claim 1, further comprising:
(II) a compound of formula II: 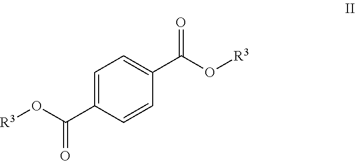
wherein each R³ is (C₃₋₆)alkyl.

6. The plasticizer composition of claim 5, wherein the compound of formula II is present at from 20 to 70 weight % based on the total weight of the plasticizer composition.

7. The plasticizer composition of claim 1, further comprising:
(III) a compound of formula III: 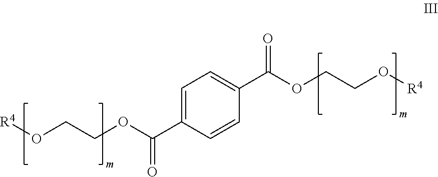
wherein:
each R⁴ is (C₁₋₆)alkyl; and
each m is 1, 2, or 3.

8. The plasticizer composition of claim 7, wherein each R⁴ is unbranched or branched butyl.

9. The plasticizer composition of claim 7, wherein: R¹ is unbranched butyl; R² is unbranched butyl; each R³ is unbranched butyl; each R⁴ is unbranched butyl; each m is 1; and n is 1.

10. The plasticizer composition of claim 7, wherein the compound of formula III is present from 2 to 30 weight % based on the total weight of the plasticizer composition.

11. A compound of formula IA: 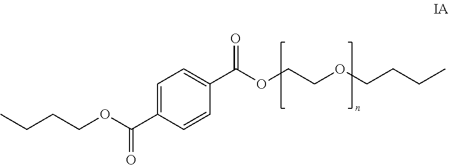
wherein n is 1 or 2.

12. A plasticizer composition comprising the compound of formula IA, 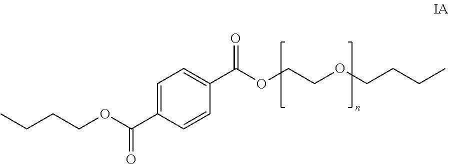
wherein n is 1 or 2, and
wherein the compound of formula IA is present at from 20 to 60 wt % based on the total weight of the plasticizer composition.

13. The plasticizer composition of claim 12, further comprising the compound of formula IIA: 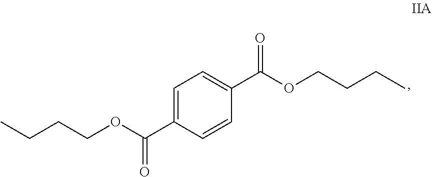 [SMILES: CCCCOC(=O)c1ccc(C(=O)OCCCC)cc1]
wherein the compound of formula IIA is present from 20 to 70 wt % based on the total weight of the plasticizer composition.

14. The plasticizer composition of claim 13, further comprising the compound of formula IIIA: 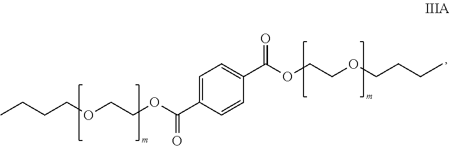
wherein the compound of formula IIIA is present from 2 to 30 wt % based on the total weight of the plasticizer composition.

15. The plasticizer composition of claim 14, wherein: each m is 1; and n is 1.

16. A resin composition comprising:
(I) a resin; and
(II) a compound of formula I
wherein: 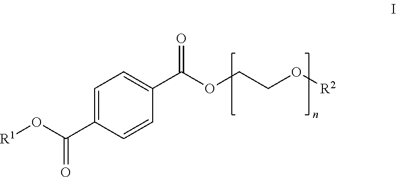
R¹ is (C₃₋₆)alkyl;
R² is (C₁₋₆)alkyl; and
n is an integer of 1, 2 or 3.

17. The resin composition of claim 16, further comprising:
(II) a compound of formula II: 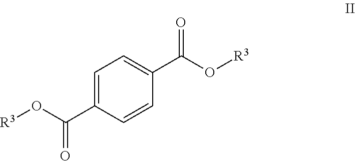
wherein each R³ is (C₃₋₆)alkyl.

18. The resin composition of claim 16, further comprising:
(III) a compound of formula III: 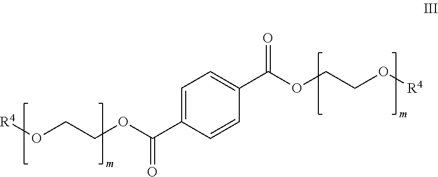
wherein:
each R⁴ is (C₁₋₆)alkyl; and
each m is 1, 2, or 3.

19. The resin composition of claim 18, R¹ is unbranched butyl; R² is unbranched butyl; each R³ is unbranched butyl; each R⁴ is unbranched butyl; each m is 1; and n is 1.

20. The resin composition of claim 17, wherein the resin comprises a polyvinyl chloride, a polyvinyl acetate, an acrylic polymer, vinyl chloride-containing copolymers, or combinations thereof.
